(19) United States
(12) Patent Application Publication
(10) Pub. No.: US 2014/0280882 A1
(43) Pub. Date: Sep. 18, 2014

(54) SYNCHRONIZATION AND ROUTING OF COMPONENTS AND DATA

(71) Applicant: CAREFUSION 303, INC., San Diego, CA (US)

(72) Inventors: Stephen LaCerte, San Diego, CA (US); Martin Orona, San Diego, CA (US)

(73) Assignee: CareFusion 303, Inc., San Diego, CA (US)

(21) Appl. No.: 13/831,665

(22) Filed: Mar. 15, 2013

(51) Int. Cl. H04L 12/24

(52) U.S. Cl. CPC H04L 41/0246
USPC 709/224

(57) ABSTRACT

A change associated with a component or entry in a data store is identified. A subscription registry is polled to determine which of a plurality of entities have subscriptions associated with the identified change. Using connection information, a synchronization operation at each of the determined entities is initiated to reflect the identified change. The change may include one or more of: a change to a server connected to a network, a change to a medical device connected to a network, a change to a software component residing on one or more medical devices, and/or a change to a data store subscribed to by at least one of one or more servers and one or more medical devices. The plurality of entities may include one or more of an infusion pump, a vital signs monitor, and a ventilator. Related apparatus, systems, techniques, articles, and computer readable media are also described.

### TECHNICAL FIELD

The subject matter described herein relates to synchronization and routing of components and data among medical devices connected to a network.

### BACKGROUND

To improve cost efficiency and patient care, hospitals and other care facilities are increasingly using medical devices such as vital signs monitors and infusion pumps. Increasingly, these devices are electronically controlled. However, currently no system exists to coordinate these medical devices to share information with each other, computing systems, and a central coordinating facility.

### SUMMARY

A change associated with at least one of a component or entry in a data store is identified. A subscription registry is polled to determine which of a plurality of entities have subscriptions associated with the identified change. Using connection information, a synchronization operation at each of the determined entities is initiated to reflect the identified change.

The change may include one or more of the following: a change to a server connected to a network, a change to a medical device connected to a network, a change to a software component residing on one or more medical devices, and/or a change to a data store subscribed to by one or more servers and one or more medical devices.

The plurality of entities may include one or more of an infusion pump, a vital signs monitor, and a ventilator. The data store includes at least one of a data store of device communications, a data store associated with a file transfer, and a data store associated with an editor.

Computer program products are also described that comprise non-transitory computer readable media storing instructions, which when executed by one or more data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The current subject matter provides many advantages. For example, the current subject matter enables enhanced synchronization amongst devices, components, and data stores which in turn allows for easier coordination and integration within a healthcare computing environment.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating a computing landscape within a healthcare environment;

FIG. 2 is an example system diagram to illustrate synchronization of device communications.

FIG. 3 is an example process diagram to illustrate synchronization of device communication; and

FIG. 4 is an example process diagram to illustrate synchronization of a data store.

Like reference symbols in the various drawings indicate like elements.

### DETAILED DESCRIPTION

FIG. 1 is a system diagram illustrating a computing landscape 100 within a healthcare environment such as a hospital. Various devices and systems, both local to the healthcare environment and remote from the healthcare environment, can interact via at least one computing network 105. This computing network 105 can provide any form or medium of digital communication connectivity (i.e., wired connection, optical connection or wireless connection) amongst the various devices and systems. Examples of communication networks include a local area network (“LAN”), a wide area network (“WAN”), and the Internet. In some cases, one or more of the various devices and systems can interact directly via peer-to-peer coupling (for example, via a hardwired connection or via a wireless protocol such as Bluetooth or WiFi). In addition, in some variations, one or more of the devices and systems communicate via a cellular data network.

In particular, aspects of the computing landscape 100 can be implemented in a computing system that includes a back-end component (e.g., as a data server 110), or that includes a middleware component (e.g., an application server 115), or that includes a front-end component (e.g., a client computer 120 having a graphical user interface or a Web browser through which a user may interact with an implementation of the subject matter described herein), or any combination of such back-end, middleware, or front-end components. A client 120 and server 110, 115 are generally remote from each other and typically interact through the communications network 105. The relationship of the clients 120 and servers 110, 115 arises by virtue of computer programs running on the respective computers and may have a client-server relationship to each other. Clients 120 can be any of a variety of computing platforms that include local applications for providing various functionality within the healthcare environment. Example clients 120 include, but are not limited to, desktop computers, laptop computers, tablets, and other computing devices that may have touch-screen interfaces. The local applications can be self-contained in that they do not require network connectivity and/or they can interact with one or more of the servers 110, 115 (e.g., a web browser).

A variety of applications can be executed on the various devices and systems within the computing landscape such as electronic health record applications, medical device monitoring, operation, and maintenance applications, scheduling applications, billing applications and the like.

The network 105 can be coupled to one or more data storage systems 125. The data storage systems 125 can include databases providing physical data storage within the healthcare environment or within a dedicated facility. In addition, or in the alternative, the data storage systems 125 can include cloud-based systems providing remote storage of data in, for example, a multi-tenant computing environment. The data storage systems 125 can also comprise non-transitory computer readable media.

Mobile communications devices (MCDs) 130 can also form part of the computing landscape 100. The MCDs 130 can communicate directly via the network 105 and/or they can communicate with the network 105 via an intermediate network such as a cellular data network or other wired or wireless network. Various types of communication protocols can be used by the MCDs 130 including, for example, messaging protocols such as SMS and MMS.

Various types of medical devices 140 can be used as part of the computing landscape 100. These medical devices 140 can comprise, unless otherwise specified, any type of device or system with a communications interface that characterizes one or more physiological measurements of a patient and/or that characterizes treatment of a patient. In some cases, the medical devices 140 communicate via peer to peer wired or wireless communications with another medical device 140 (as opposed to communicating with the network 105). For example, the medical device 140 can comprise a bedside vital signs monitor that is connected to other medical devices 140, namely a wireless pulse oximeter and to a wired blood pressure monitor. One or more operational parameters of the medical devices 140 can be locally controlled by a clinician, controlled via a clinician via the network 105, and/or they can be controlled by one or more of a server 115, client 120, data storage systems 125, MCD 130, and/or another medical device 140.

The computing landscape 100 can provide various types of functionality as may be required within a healthcare environment such as a hospital. For example, a pharmacy can initiate a prescription via one of the client computers 120. This prescription can be stored in the data storage systems 125 and/or pushed out to other clients 120, an MCD 130, and/or one or more of the medical devices 140. In addition, the medical devices 140 can provide data characterizing one or more physiological measurements of a patient and/or treatment of a patient (e.g., medical device 140 can be an infusion management system, etc.). The data generated by the medical devices 140 can be communicated to other medical devices 140, the servers 110, 115, the clients 120, the MCDs 130, and/or stored in the data storage systems 125.

FIG. 1 depicts an example of a centralized system (CS) 100 consistent with some implementations. The CS 100 includes the computing devices and medical devices 140 connected to network 105. Computing devices connected to network 105 include clients 120, backend server(s) 110, application server(s) 115, data storage systems 125, and MCD 130. Computing devices 110, 115, 120, 125, and 130 may connect to the network 105 through any wired or wireless access network including cellular data network 135 or other network. Some medical devices can connect directly to network 105.

FIG. 2 depicts an example of a logical instance 200 of a CS. The logical instance 200 of the CS can include a complete CS system for a hospital, building, company, organization, or location. In some implementations such as the logical instance in FIG. 2, the logical instance can include multiple physical instances connected through a network such as network 105 to form a single system. In some implementations, a logical instance can include one physical instance. Sometimes the logical instance of a CS is referred to as just a CS and a physical instance of a CS is referred to as a server.

In the example shown in FIG. 2, the logical instance 200 includes three physical instances—server 210A, server 210B, and server 210C. The servers are connected together through network 105. Each server can be also connected to one or more medical devices. In the example of FIG. 2, server 210A is connected to medical devices 220E and 220F, server 210B is connected to medical device 220D, and server 210C is connected to medical devices 220B and 220C. In some systems, the server can be connected to a large number of medical devices (e.g., thousands of medical devices, etc.). One or more servers such as server 210A can be connected to the internet 240. One or more user interfaces such as user interface 230A, user interface 230B, and/or user interface 230C can access a server within the CS 200 in order to issue commands to one or more components of the CS 200, and/or to update, or otherwise modify one or more parameters in the CS 200.

Network 105 provides for communication through connections 205 between computing devices such as servers 210A-C, and communication through connections 205 between medical devices 220A-220F and servers 210A-210C. A server such as server 210A can also have a connection 207 to the internet 240. A user interface, such as user interface 230A can access the CS through connections 207 and the internet 240. Server or medical device 250 can also be connected to network 105 though the internet 240. Each connection 205 and 207 can be a wired or wireless connection, a serial connection, parallel connection or any other type of communication connection. Connections 207 can include additional gateways or routers to access the internet.

Servers such as server 210A can connect to between one and thousands of medical devices. In the example of FIG. 2, server 210A connects to medical devices 220E and 220F. When multiple medical devices are connected to a server, they can connect through a switch or router not shown in FIG. 2. The connection 205 between a medical device and the server can be a wired or wireless connection. The server such as server 210A can provide commands that are individually addressed to one of the connected medical devices. Commands can also be broadcast to multiple medical devices. Status data, maintenance data, usage data, and other data can be received at the server from any attached medical device. Each server such as server 210A can maintain a list of medical devices connected to it such as medical devices 220E and 220F. The list of medical devices connected to the CS 200 is sometimes referred to as a registry.

Some information stored on each server such as server 210A can be shared with the other servers in the CS 200 in order to have the same information stored on each server. This process is sometimes called synchronization. Synchronization of the CS 200 can involve synchronization components such as synchronization of device communications, synchronization of data stores, synchronization of file transfers, synchronization of routing, and synchronization of editor information. Other types of synchronization are also possible.

Synchronization of device communication can involve the servers such as servers 210A-210C exchanging information about the medical devices connected to each server. The information exchanged about any particular medical device can be called a device data package and can include identification of the type of device, the status of the device, the location of the device and other parameters. Synchronization of device communications can result in device data packages being exchanged between servers such that each server stores the device data packages for all of the medical devices connected to the CS including medical devices connected to other servers. For example, upon synchronization of device communication, server 210A can send device data packages for medical devices 220E and 220F or a representation of the data packages or update information to server 210B and server 210C. This can result in servers 210B and 210C receiving device information about the medical devices connected to server 210A. Similarly, synchronization of device communication can cause server 210B to send the device data packages for medical device 220D or a representation of the data packages or update information to server 210A and server 210C. Server 210C can similarly send device data packages for medical devices 220B and 220C to servers 210A and 210B. At the completion of the synchronization of device communication, servers 210A-C can each have medical device information for all of the medical devices connected to the CS 200 including devices connected to a server such as servers 210A-C and devices connected directly to the network. In this way, a user interface, such as user interface 230B connected to server 210B can have access to medical device information for all the medical devices connected the CS 200. Although medical devices are generally available for device synchronization, some devices may not be available.

Servers and medical devices that are part of a particular synchronization such as synchronization of device communications are said to be subscribed to that particular synchronization. Not all devices and servers need to be subscribed to every type of synchronization.

When a device such as medical device 260 is first connected to a server such as server 210C, discovery of the added medical device can occur. Discovery includes the exchange of information including an identification of the type of device, the status of the device, the location of the device and other parameters that may be included in the device data package. Upon the completion of discovery of medical device 260, server 210C can add the device data package associated with medical device 260 to the list of medical devices connected to server 210C. When the next synchronization of device communication occurs, the device data package associated with the newly attached medical device 260 can be sent to the other servers in the CS 200 as part of the exchange with the other servers.

Commands and messages to a medical device can be sent via the wired or wireless connection 205 between the server and medical device. For example, user interface 230B can send a command to, or receive information from, medical device 220D via connections 205. Synchronization of communication can provide support for routing of commands or messages to medical devices connected to any of the servers making-up the CS 200. For example, after synchronization of communication, user interface 230B can send commands to, or receive information from, medical device 220B connected to server 210C. The routing from user interface 230B through server 210B, through the network 105, through server 210C, to medical device 220B can be facilitated by the synchronization of communication on the CS 200.

Medical devices at a location such as in a particular patient area 270 serving a particular patient 280 do not need to be connected to the same server. For example, medical device 220E can be connected to server 210A and medical device 220D may be connected to server 210B while serving the same patient 280. Information can be shared between devices connected to different servers by routing the information through the network. Synchronization of device communication and routing facilitate this.

Medical device such as medical devices 220A-F can include any combination of devices such as infusion pumps (e.g., peristaltic pumps, large volume infusion pumps, syringe pumps, patient-controlled analgesia systems, etc.), ventilators, vital signs monitors, and other network enabled medical devices.

User interfaces such as user interface 230A-C can facilitate sending commands and receiving information from any device in the CS 200. Before accessing commands or information, authentication of the user at the user interface can be required by the CS 200. For example, a user at user interface 230A can access the CS through connection 207 to the internet 240, and connection 207 to server 210A. The user at user interface 230A can be required to provide authentication information at the user interface 230A, at the server 210A or both. Upon authentication, the user can have access to sending commands to medical devices connected to the CS or receiving information form the medical devices. The authentication credentials of a user can limit the types of commands that a user is allowed to send, the types of information the user is allowed to receive, and/or or the medical devices that the user may access. For example, a particular user may be able to receive only maintenance information from the medical devices on the CS 200 and no other information, and may not be allowed to send commands to the medical devices. For example, these limitations or similar limitations can be imposed on maintenance personnel at a hospital. Other examples include the physician for patient 280 who may be authorized to adjust a dosage level at medical device 220D or 220E where the maintenance personnel would not be authorized to adjust dosages. Other limitations of sets of limitations are also possible.

FIG. 3 depicts a process for synchronization of device communication according to some embodiments. Process 300 depicts synchronization of device communications of a newly added medical device to the network 105, or to one of servers 210A-C. After being connected at 310, discovery of the medical device occurs at 320. Upon discovery, the added medical device sends a device data package to its controlling server at 330. At 340, each server subscribed to the synchronization of device communications is updated to include the added device. Although the synchronization of device communications is described as an added medical device, the process can be used to add a server or other device as well.

At 310, a medical device is added to the centralized system. For example, a medical device such as medical device 220E may be brought to the patient area 270 of patient 280. For example, medical device 220E could be an infusion pump, pulse oximeter, or other device. The medical device 220E may have the capability to either make a wired connection 205 to a server 210A, or a wireless connection 205 to server 210A. If a wired connection is used, the medical device 220E is physically connected via a cable to a server such as server 210A. If a wireless connection is used, the wireless capability of medical device 220E and server 210A are enabled. Medical device 220E may or may not have been previously connected to CS 200. For example, the specific model and serial number of medical device 220E may have been previously connected to the centralized system 200, or just the model of the medical device 220E may have been previously connected to the centralized system but not the particular serial number of medical device 220E, or medical device 220E may be a new model and serial number that has never been connected to the centralized system 220E.

At 320, discovery occurs of the medical device such as discovery of medical device 220E added to the centralized system. Discovery involves making a data connection through connection 205 between the server 210A and medical device 220E through a wired or wireless interface.

As part of discovery of the added device, a device data package is sent from the medical device 220E to the server 210A at 330. The device data package can include identification of the type of device, the status of the device, the location of the device and other parameters that may be included in the device data package. Upon the completion of discovery of medical device 220E, server 210A can add the device data package associated with medical device 220E to the data store or registry of medical devices connected to server 210A.

At 340, the device data package associated with added medical device 220E can be sent to the other servers in the CS 200 as part of the synchronization of device communication. Each server subscribed to the synchronization of device communication adds the device data package from the added medical device 220E to its data store or registry of medical devices connected to the CS 200.

Another synchronization component is the data store synchronization process shown in FIG. 4. Process 400 can synchronize a data store across CS 200. Synchronization ensures that the data in a particular data store made available to a user through a user interface and available to each subscribed server in the CS 200 contains the same data. The process includes an identification of a change to a data store entry at 410, the generation of a notification message 420, and the distribution of the notification message to devices subscribing to the data store.

At 410, at least one change to one or more data stores is identified. Examples of data stores include (unless otherwise specified) any sort of data storage including data stores with medical device information, data stores with patient information, and data stores with user authentication information. Other data stores can also be used. The data store change may be made by a user at a user interface such as user interface 230B. For example, the user at user interface 230B can change data in a patient information data store associated with a particular patient such as the patient's room number.

At 420, a notification message is generated that provides relevant details about the changed data store entry. For example, the notification message can include in addition to the room number change the patient name, patient identification number, name or identification number of the patient's physician, and/or any other information that would be valuable to recipients of the notification message.

At 430, the notification message is distributed to all devices subscribing to the particular data store that has been changed. For example, servers 210A-210C may subscribe to the patient information data store and so would receive the notification message through network 105. Other computing devices can also subscribe to the data store including a backend server 110, application server 115, MCD 130 and/or data storage systems 125.

Each data store can be maintained at a central location such as at data storage systems 125, or the data store may be maintained in multiple devices such as at data storage systems 125, and server 210A. In this example, server 210A and data storage systems 125 subscribe to the data store. For example, a user at user interface 230A can change an entry to a data store at server 210A. As a result of the changed data store entry at server 210A, a notification messages are sent to data storage systems 125 but not to servers 210B or 210C because they are not subscribed to the data store. In this way, the subscribing devices are made aware of the changes that have been made to a data store to which they subscribe. If the data store is maintained at multiple storage locations, such as both at server 210A and data storage systems 125, data systems 125A uses the notification message to update the data store at that location. If the data store is maintained a one location, for example at server 210A, data storage systems is made aware of the data store change but does not update its data store based on the notification message.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A computer-implemented method comprising:
identifying a change associated with at least one of a component or entry in a data store;
polling a subscription registry to determine which of a plurality of entities have subscriptions associated with the identified change; and
initiating, using connection information, a synchronization operation at each of the determined entities to reflect the identified change.

2. The computer-implemented method of claim 1, wherein the change comprises a change to a server connected to a network.

3. The computer-implemented method of claim 1, wherein the change comprises a change to a medical device connected to a network.

4. The computer-implemented method of claim 1, wherein the change comprises a change to a software component residing on one or more medical devices.

5. The computer-implemented method of claim 1, wherein the change comprises a change to a data store subscribed to by at least one of one or more servers and one or more medical devices.

6. The computer-implemented method of claim 1, wherein the plurality of entities comprises one or more of an infusion pump, a vital signs monitor, and a ventilator.

7. The computer-implemented method of claim 1, wherein the data store comprises at least one of a data store of device communications, a data store associated with a file transfer, and a data store associated with an editor.

8. A non-transitory computer readable medium encoded with instructions which, when executed by at least one processor, perform at least the following:
identify a change associated with at least one of a component or entry in a data store;
poll a subscription registry to determine which of a plurality of entities have subscriptions associated with the identified change; and
initiate, using connection information, a synchronization operation at each of the determined entities to reflect the identified change.

9. The non-transitory computer readable medium of claim 8, wherein the change comprises a change to a server connected to a network.

10. The non-transitory computer readable medium of claim 8, wherein the change comprises a change to a medical device connected to a network.

11. The non-transitory computer readable medium of claim 8, wherein the change comprises a change to a software component residing on one or more medical devices.

12. The non-transitory computer readable medium of claim 8, wherein the change comprises a change to a data store subscribed to by at least one of one or more servers and one or more medical devices.

13. The non-transitory computer readable medium of claim 8, wherein the plurality of entities comprises one or more of an infusion pump, a vital signs monitor, and a ventilator.

14. The non-transitory computer readable medium of claim 8, wherein the data store comprises at least one of a data store of device communications, a data store associated with a file transfer, and a data store associated with an editor.

15. An apparatus comprising:
at least one processor; and
at least one memory storing computer program code, the at least one processor, the at least one memory, and the computer program code configured to cause the apparatus to at least:
identify a change associated with at least one of a component or entry in a data store;
poll a subscription registry to determine which of a plurality of entities have subscriptions associated with the identified change; and
initiate, using connection information, a synchronization operation at each of the determined entities to reflect the identified change.

16. The apparatus of claim 15, wherein the change comprises a change to a server connected to a network.

17. The apparatus of claim 15, wherein the change comprises a change to a software component residing on one or more medical devices.

18. The apparatus of claim 15, wherein the change comprises a change to a data store subscribed to by at least one of one or more servers and one or more medical devices.

19. The apparatus of claim 15, wherein the plurality of entities comprises one or more of an infusion pump, a vital signs monitor, and a ventilator.

20. The apparatus of claim 15, wherein the data store comprises at least one of a data store of device communications, a data store associated with a file transfer, and a data store associated with an editor.
